(19) United States
(12) Patent Application Publication
(10) Pub. No.: US 2023/0001441 A1
(43) Pub. Date: Jan. 5, 2023

(54) WATER FOUNTAIN

(71) Applicants: Ronit Khushu, San Diego, CA (US); Riya Khushu, San Diego, CA (US); Sanjeev Khushu, San Diego, CA (US)

(72) Inventors: Ronit Khushu, San Diego, CA (US); Riya Khushu, San Diego, CA (US); Sanjeev Khushu, San Diego, CA (US)

(21) Appl. No.: 17/854,796

(22) Filed: Jun. 30, 2022

Related U.S. Application Data
(60) Provisional application No. 63/217,564, filed on Jul. 1, 2021.

(51) Int. Cl. B05B 17/08

(52) U.S. Cl. CPC B05B 17/085

(57) ABSTRACT

A fountain for both rainfall effect and/or waterfall effect. The fountain includes an inner pipe and an outer pipe. One end of both the inner pipe and the outer pipe is closed and another end is open. Each the inner pipe and the outer pipe has several holes made linearly along a length of inner pipe and the outer pipe. The outer pipe encases the inner pipe such that the holes in the inner pipe face upwards while the holes in the outer pipe face downwards when the fountain is horizontally aligned. The water supply is connected to the open end of the inner pipe.

### CROSS-REFERENCE TO RELATED APPLICATIONS

This application claims priority from a U.S. Provisional Patent App. No. 63/217,564 filed on Jul. 1, 2021, which is incorporated herein by reference in its entirety.

### FIELD OF INVENTION

The present invention relates to a water fountain with a rainfall effect, and more particularly, the present invention relates to a gravity-based water fountain with rainfall and waterfall effects.

### BACKGROUND

Water features/fountains with a “rainfall” effect are expensive, and harder to build/manufacture, maintain, and install. The rainfall effect needs water to be regulated uniformly throughout the entire length of the fountain to get the true “rainfall” effect. The process to build, install, assemble, and test the fountain with rainfall effect is time-consuming, especially if the length of the fountain is of several feet. The rainfall feature also has a high chance of clogging, requiring expensive maintenance and repairs. Overall, the cost and maintenance of known fountains with rainfall effect is high.

Besides the rainfall effects, additional effects such as a user also desires waterfall effects. For both the rainfall effect and waterfall effect, two separate units are needed which are built and made separately. A rainfall fountain functions as a rainfall fountain only. Similarly, a waterfall fountain is limited to a single waterfall effect. It increases the overall cost and results is complex and difficult-to-use water fountain.

Thus, a need is therefore appreciated for a water fountain with interchangeable rainfall and the waterfall effects that is devoid of the drawbacks of the known rainfall and waterfall fountains.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a water fountain with a rainfall effect that operates under gravity.

It is another object of the present invention that the construction of the fountain is not complex.

It is still another object of the present invention that there is a uniform flow of water across any desired length of the fountain.

It is a further object of the present invention that the fountain can be quickly built and installed.

It is yet another object of the present invention that the fountain is easy and cost-effective to maintain.

It is a further object of the present invention that the fountain can be dynamically configurable to get different results & effects, like rainfall, waterfall, or waterspout.

It is still a further object of the present invention that the chances of clogging are significantly reduced eliminating the need for expensive filters and repairs.

In one aspect, disclosed is a fountain comprising an inner pipe that has a closed end and an open end, the inner pipe has a plurality of holes along a length of the inner pipe; and an outer pipe that has a closed end and an open end, the outer pipe has one or more holes, the one or more holes are along a length of the outer pipe, the outer pipe encases the inner pipe such that the plurality of holes in the inner pipe face upwards and the one or more holes in the outer pipe face downwards when the fountain is horizontally aligned, wherein the open end of the outer pipe and the open end of the inner pipe are adjacent to each other, wherein the open end of the inner pipe is configured to receive a water supply. The one or more holes in the outer pipe comprises a plurality of holes arranged linearly. The one or more holes in the outer pipe comprises an elongated slot that extends along the length of the outer pipe. The outer pipe further comprises a plurality of holes arranged linearly along the length of the outer pipe, wherein the outer pipe is configured to be rotated relative to the inner pipe to switch between a waterfall effect and a rainfall effect. The plurality of holes of the inner pipe decreases in diameter from the open end up to the closed end of the inner pipe. The plurality of holes are equally spaced from each other, wherein the plurality of holes are dispersed throughout the length of the outer pipe.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1a is a planar view of a fountain for rainfall effect, according to an exemplary embodiment of the present invention.

FIG. 1b is a planar view of an inner pipe of the fountain shown in FIG. 1a, according to an exemplary embodiment of the present invention.

FIG. 1c is a planar view of an outer pipe of the fountain shown in FIG. 1a, according to an exemplary embodiment of the present invention.

FIG. 2a is a planar view of a fountain for the waterfall effect, according to an exemplary embodiment of the present invention.

FIG. 2b is a planar view of an inner pipe of the fountain shown in FIG. 2a, according to an exemplary embodiment of the present invention.

FIG. 2c is a planar view of an outer pipe of the fountain shown in FIG. 2a, according to an exemplary embodiment of the present invention.

FIG. 3 shows an outer pipe of another embodiment of the fountain for both waterfall effect and the rainfall effect, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be outlined in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

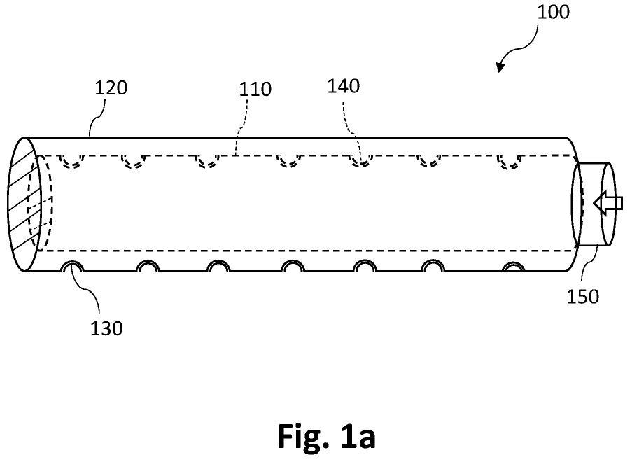

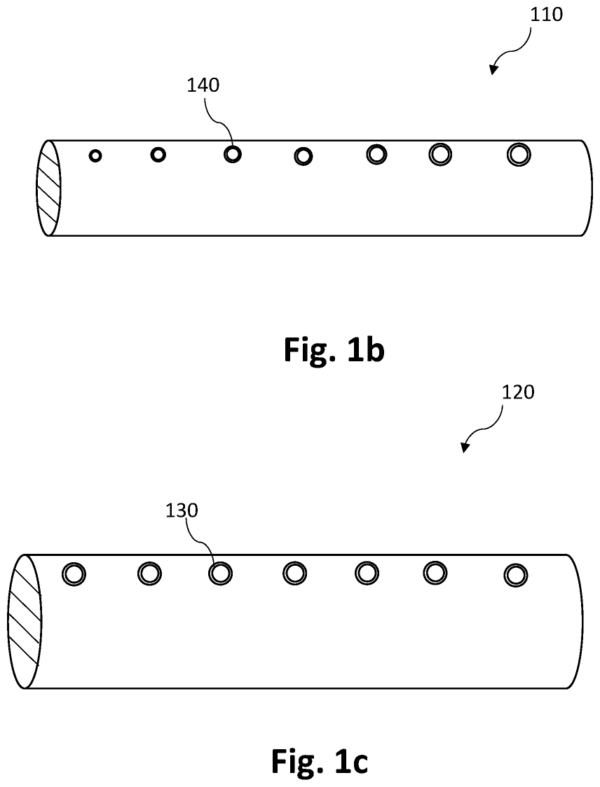

Disclosed is a fountain that has a rainfall effect and/or a waterfall effect, and that can be modified for different special effects easily and quickly. The disclosed fountain is economical to manufacture and maintain. The rainfall effect can be achieved using the earth's gravity and without having any complex mechanism. Referring to FIG. 1a which shows the fountain 100 that includes the inner pipe 110 and the outer pipe 120. The holes 130 in the outer pipe 120 face downwards while the holes 140 in the inner pipe 110 face upwards. The inner pipe can be connected to a water supply 150 using a watertight connection. The inner pipe can then be inserted into the outer pipe from the open end of the outer pipe, wherein the open ends of the inner pipe and the outer pipe are on the same sides. The holes 140 of the inner pipe face upwards against the surface of the ground. The holes 130 in the outer pipe face the ground.

FIG. 1b shows the inner pipe 110 of the disclosed fountain 100. The inner pipe 110 can have an elongated tubular body made from a water-resistant material, such as PVC. FIG. 1c shows an outer pipe 120 encasing the inner pipe 110. Both the inner pipe and outer pipe are creatively modified and installed, allowing the earth's gravity to ensure uniform flow across the entire length of the fountain giving the true effect of “rainfall” and other features like “waterfall” from the same installed unit. The outer pipe can also be made from a water-resistant material, such as PVC. In one implementation, both the inner pipe and the outer pipe can be made from the same material or a different one. The outer pipe is larger in diameter than the inner pipe so that the outer pipe can encase the inner pipe.

In one implementation, the tubular body of the inner pipe 110 can be about 10 feet in length and 1.5 inches in diameter. One end of the inner pipe is closed while the other end is open. For example, a plug can be used to close the end of the inner pipe. The other open end can act as an inlet for water. The inner pipe can have a series of holes along its length in a row. The holes are equally spaced from each other. The holes can be made straight and optionally tapered. For example, in a 10 feet pipe, the first and the last hole can be about 9.5 feet apart. In a preferred embodiment, the diameter of the holes can gradually decrease from the first hole up to the last hole, wherein the first hole is adjacent to the open end of the inner pipe. In one implementation, the first hole can be about 10 mm in diameter, and the diameter of the holes can gradually decrease such that the middle hole can be about 5 mm in diameter and the last hole that is adjacent to the closed end of the inner pipe can be about 2 mm in diameter.

The outer pipe 120 can have a tubular body of a diameter larger than the diameter of the inner pipe 110. For example, the outer pipe can be about ten feet in length and about two inches in diameter. One end of the outer pipe can be closed while the other end can be open to receive the inner pipe. Holes can be made in the outer pipe for the desired water effect. For example, for the rainfall effects, evenly spaced holes 130 can be made along the length of the outer pipe in a row. The width of the holes can be varied for the desired effect. In one implementation, the holes 210 can be about 1/16 inches in diameter and all the holes can be equal in diameter. For ten feet outer pipe, the first hole and the last hole can be about 9.5 feet apart and the holes can be 0.5 inches apart from each other.

When water is supplied to the inner pipe, the water in the inner pipe can rise through the holes 140 against gravity and eventually spill over uniformly across the length of the outer pipe. With the help of gravity, water from the outer pipe can uniformly fall through the evenly spaced holes 130 across the length of the outer pipe to give a true “rainfall” effect/feature.

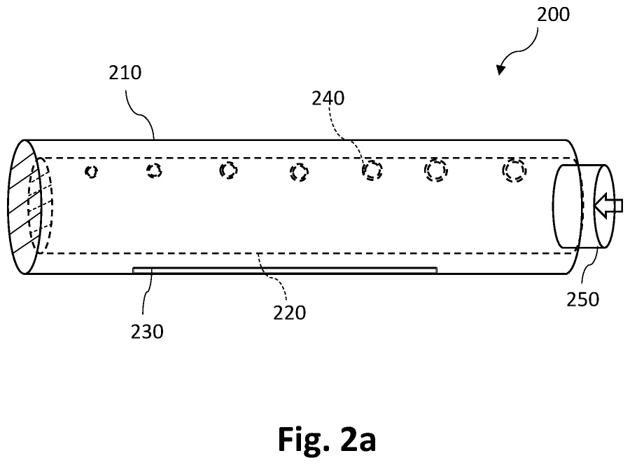

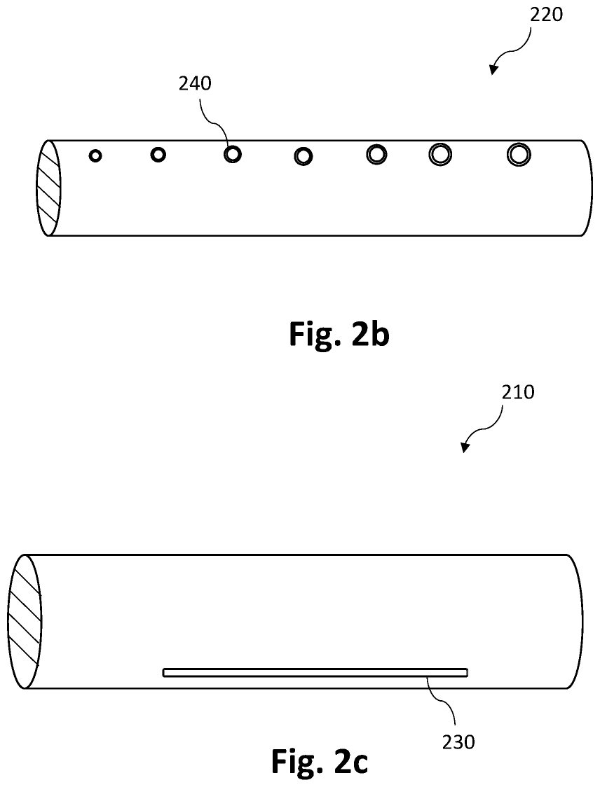

Referring to FIGS. 2a-2c which show an exemplary embodiment of the disclosed fountain 200 that produces a waterfall effect. The fountain 200 can have an outer pipe 210, an inner pipe 220, an elongated slot 230 in the outer pipe, and several holes 240 in the inner pipe. FIG. 2b shows the inner pipe 220 that can be similar to the inner pipe 110 shown in FIG. 1b. FIG. 2c shows the outer pipe 210 that is similar to the outer pipe 120 shown in FIG. 1c, except, the outer pipe 210 has an elongated slot to produce the waterfall effect. FIG. 2c shows a single elongated slot that extends along a length of the outer pipe, however, more than one elongated slot in the outer pipe 210 are within the scope of the present invention. In the fountain 200, the elongated slot of the outer pipe faces downwards and the holes in the inner pipe face upwards.

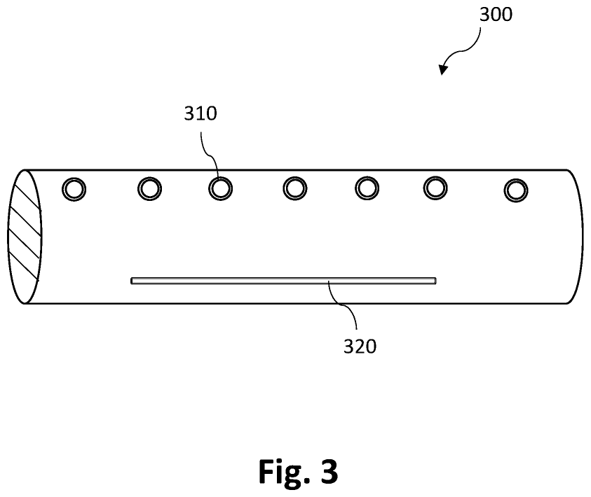

The one implementation, the outer pipe 210 can be further modified to include both the rainfall effect and the waterfall effect, wherein the outer pipe can be rotated to switch between the rainfall effect and the waterfall effect. FIG. 3 shows an embodiment the outer pipe 300 that has multiple holes 310 arranged in a row for the rainfall effect and an elongated slot 320 for the waterfall effect. To get the “waterfall” effect/feature from the same unit, the outer pipe can be rotated about 90 degrees so that the holes 310 face sidewards and the elongated slot 320 faces downwards. The water from the inner pipe can fall through the elongated slot of the outer pipe resulting in the waterfall effect. To switch from the waterfall effect to rainfall effect, the outer pipe can again be rotated so that the holes 310 faces downwards. The inner pipe and the arrangement of the inner pipe and the outer pipe can remain the same as in other embodiments, except the outer pipe can be rotated between two stops.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A fountain comprising:
an inner pipe that has a closed end and an open end, the inner pipe has a plurality of holes along a length of the inner pipe; and
an outer pipe that has a closed end and an open end, the outer pipe has one or more holes, the one or more holes are along a length of the outer pipe, the outer pipe encases the inner pipe such that the plurality of holes in the inner pipe face upwards and the one or more holes in the outer pipe face downwards when the fountain is horizontally aligned,
wherein the open end of the outer pipe and the open end of the inner pipe are adjacent to each other, wherein the open end of the inner pipe is configured to receive a water supply.

2. The fountain according to claim 1, wherein the one or more holes in the outer pipe comprises a plurality of holes arranged linearly.

3. The fountain according to claim 1, wherein the one or more holes in the outer pipe comprises an elongated slot that extends along the length of the outer pipe.

4. The fountain according to claim 3, wherein the outer pipe further comprises a plurality of holes arranged linearly along the length of the outer pipe, wherein the outer pipe is configured to be rotated relative to the inner pipe to switch between a waterfall effect and a rainfall effect.

5. The fountain according to claim 1, wherein the plurality of holes of the inner pipe decreases in diameter from the open end up to the closed end of the inner pipe.

6. The fountain according to claim 2, wherein the plurality of holes are equally spaced from each other, wherein the plurality of holes are dispersed throughout the length of the outer pipe.
